(19) United States
(12) Patent Application Publication
(10) Pub. No.: US 2002/0150441 A1
(43) Pub. Date: Oct. 17, 2002

(54) Wrapped driving anvil

(76) Inventor: John D. Pratt, Laguna Niguel, CA (US)

Correspondence Address: TBGB&M, 36th Floor, 105 W. Adams, Chicago, IL, 60603, US

(21) Appl. No.: 09/835,225

(22) Filed: Apr. 13, 2001

(51) Int. Cl. F16B 13/06

(52) U.S. Cl. 411/45

(57) ABSTRACT

An anvil is provided for use in a blind fastening system. The anvil is made using a process of wrapping a piece of wire stock around a mandrel. This process provides significant cost advantages compared to the process of machining the anvil.

BACKGROUND OF THE INVENTION

This invention is generally directed to an anvil for use in a blind fastening system. More particularly, the invention contemplates an anvil which is more cost efficiently manufactured. A related application entitled “WRAPPED SHIFT WASHER” was filed on Apr. 13, 2001 and is also owned by the assignee of this application.

Blind fastening systems are designed to allow work pieces to be fastened together without requiring access to the rear or “blind” side of the work pieces. An example of such a blind fastening system is shown in FIGS. 1-4.

As shown in FIG. 1, the prior art blind fastener 18 is installed by passing a sleeve 20 and a stem 22 of the fastener 18 through holes in the work pieces 24, 26 so that a tail 28 of the stem 22 protrudes through the rear or blind side of the work pieces 24, 26. A head portion 30 of the sleeve 20 is enlarged to prevent the sleeve 20 from passing entirely through the work pieces 24, 26.

Fasteners 18 such as the one shown in FIG. 1, are installed using an ordinary push-pull type installation tool. The installation tool generally includes a gripping member 32 which grips and pulls the end of the stem 22 which protrudes from the head portion 30 of the sleeve 20 and a driving member 34 which applies an equal and opposite force to the sleeve 20 of the fastener 18 by way of the anvil 36 and the locking collar 38.

The anvil 36 shown in FIGS. 1-4 has an upper portion 40 and a lower portion 42. The upper portion 40 extends outwardly from the lower portion 42 and provides a platform upon which the driving member 34 of the installation tool can rest. The lower section 42 rests on the locking collar 38.

As shown in FIG. 2, as the gripping member 32 pulls the stem 22 of the fastener 18, the driving member 34 pushes against the upper portion 40 of the anvil 36. As shown in FIG. 3, the driving member 34 is pushed towards the work pieces and the lower portion 42 of the anvil 36 drives the malleable locking collar 38 into a cavity 44 between the sleeve 20 and the stem 22 to prevent disengagement of the stem 22 and the sleeve 20.

After installation, the stem 22 is broken at A reduced portion 22a to provide a finished installed fastener as shown in FIG. 4 and the anvil 36 is discarded.

The anvil 36 is used in the prior art fastening systems are used to prevent wear on the driving member 34 of the installation tool. The prior art anvil 36 is typically made by machining solid bar stock. During the machining process a lathe is used to form the desired outer diameters of the upper section 40 and the lower section 42 of the anvil 36. A drill is used to form the desired inner diameter of the anvil 36. Each of these machining steps adds expense and time to the production of the anvil 36. Additionally, a substantial amount of scrap material results from the process of machining the anvil 36.

The present invention provides a novel anvil which overcomes the problems presented in the prior art and which provides additional advantages over the prior art. Such advantages will become clear upon a reading of the attached specification in combination with a study of the drawings.

### OBJECTS AND SUMMARY OF THE INVENTION

An object of the present invention is to provide an anvil for use in a fastening system which is manufactured more cost efficiently than prior art anvils.

Another object of the present invention is to provide an anvil which functions with greater consistency during use in the blind fastening system.

Briefly, and in accordance with the foregoing, the present invention discloses an anvil which is not formed using a machining process but rather is wrapped from wire stock. The anvil can be created faster than the prior art anvil and the process for creating the anvil results in less waste. Thus, the cost of manufacturing the anvil of the present invention is significantly reduced.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a fragmentary cross-sectional view of a blind fastening system of the prior art, incorporating an anvil, positioned relative to a pair of work pieces, shown in cross-section, which are to be fastened together;

FIG. 2 is a fragmentary cross-sectional view of the prior art blind fastening system of FIG. 1 at an intermediate stage of the installation process;

FIG. 3 is a fragmentary cross-sectional view of the prior art blind fastening system of FIG. 1 at a further intermediate stage of the installation process;

FIG. 4 is a fragmentary cross-sectional view of the prior art blind fastening system of FIG. 1 at the final stage of the installation process;

FIG. 5 is a perspective view of an anvil of the present invention;

FIG. 6 is a perspective view of a wire stock which is used to make the anvil of FIG. 5;

FIG. 7a is a perspective view of wire stock and a mandrel and a brace which are used to wrap the wire stock.

FIG. 7b is a perspective view of a partially wrapped anvil and the mandrel, brace used to wrap the anvil; and

FIG. 8 is a cross-sectional view of the anvil along line 8-8 of FIG. 5.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

The novel anvil 60 of the present invention is shown in FIGS. 5-8. As shown in FIG. 5, the anvil 60 includes a cylindrically shaped tubular first portion 62 and a second portion 64. The first portion 62 has a bottom end 66 and a top end 68. The second portion 64 extends radially outwardly from the top end 68 of the first portion 62. A central passageway 74 is provided through the center of the first portion 62 and the second portion 64. A slot 72 extends through the first portion 62 and the second portion 62 and is in communication with the passageway 74. Two free ends 70 are provided on either side of the slot 72.

Unlike the prior art anvils which are made by machining bar stock, the anvil 60 of the present invention is formed from wire stock 80 which is wrapped. As shown in FIG. 6, the wire stock 80 used to from the anvil 60 includes elongated rectangular first portion 82 and an elongated rectangular second portion 84 perpendicular to the elongated first portion 82. Side 85a of the wire stock 80 will define the wall of the central passageway 74 through the anvil 60 and side 85b of the wire stock 80 will form the exterior surface of the anvil 60.

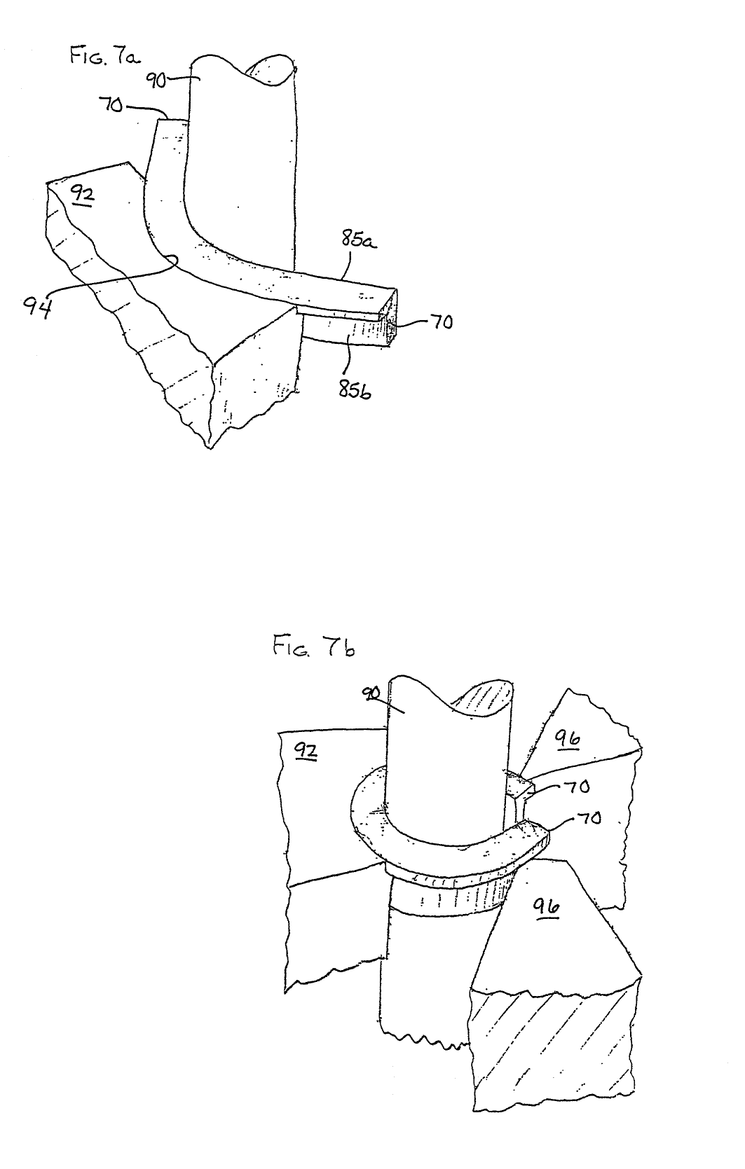

As shown in FIG. 7a, to form the anvil 60, the wire stock 80 is cut to a predetermined length, creating the two free ends 70. Side 85a of the wire stock 80 is placed against a mandrel 90. A brace 92 with a generally U-shaped groove 94 is placed against the side 85b of the wire stock 80. As the mandrel 90 is brought within the U-shaped groove of the brace 92, the wire stock 80 is wrapped around the mandrel 90 so that the side 85a of the wire stock 80 follows the curvature of the mandrel 90 and the side 85b of the wire stock 80 follows the curvature of the U-shaped groove 94 of the brace 92. Two arms 96 are then used to force the two free ends 70 against the mandrel 90 to complete the wrapping of the anvil 60 around the mandrel 90 as shown in FIG. 7b. Depending upon the length of the wire stock 80 and the dimensions of the mandrel 90, the free ends 70 may or may not abut each other. The angle of the slot 72 depends upon the length to which the wire stock 80 has been cut and the diameter of the mandrel 90 around which the wire stock 80 is wrapped. It has been found that the angle of the slot 72 can be as large as sixty degrees (60°) without significantly impacting the performance of the anvil. The smaller the angle of this slot however, the more similarly the anvil 60 will function like the prior art machined anvil. The anvil 60 is then removed from the mandrel 90 and is ready for assembly with the remaining parts of the fastening system.

The L-shaped cross section of the wire stock 80 used to form the anvil 60 can be seen in FIG. 8. Side 85a of the wire stock 80 defines the central passageway 74 through the anvil 60. Side 85b forms the exterior surface of the anvil 60.

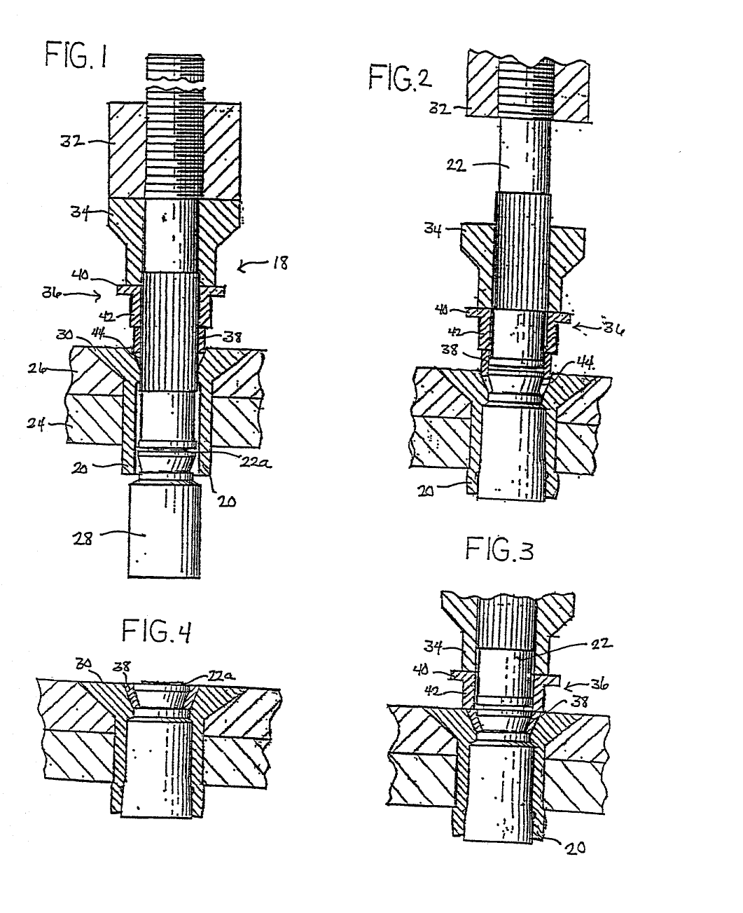

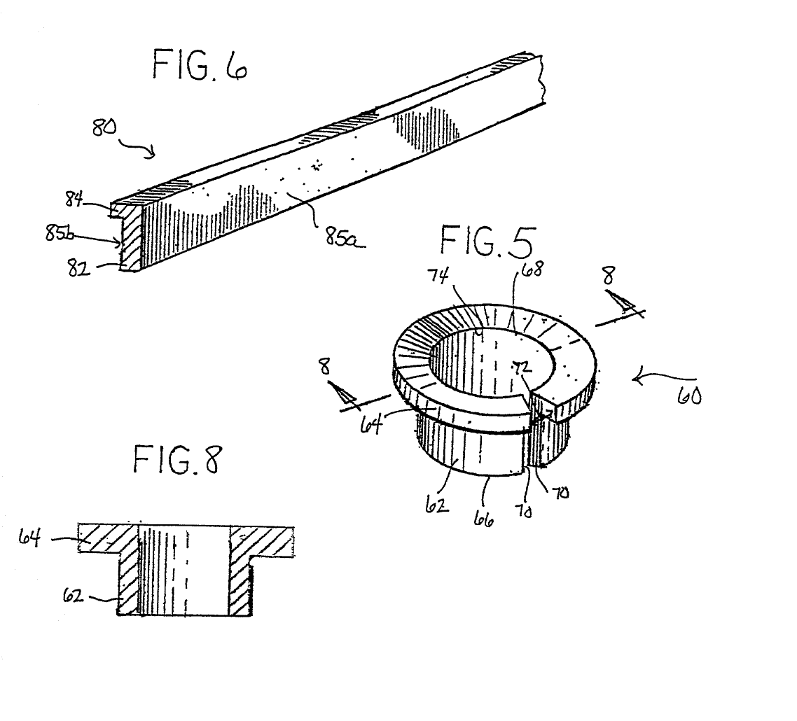

As shown in FIGS. 1-4, the malleable locking collar 38 is designed to fill the gap 44 between the sleeve 20 and the stem 22. With the anvil 60 of the present invention, because the anvil 60 includes a slot 72, rather than filling the gap 44, a portion of the malleable locking collar 38 may bleed into the slot 72. The larger the slot 72, the more bleeding that will occur and the smaller the slot 72, the less bleeding will occur. Thus the smaller the slot 72, the closer the anvil 60 will function to a machined anvil.

The process of forming the anvil 60 using a wrapping process results in very little material waste. First the wire stock 80 can be cut precisely to the length desired to form an anvil with a desired diameter. Second, the wire stock 80 is formed to provide the upper and lower portions 62,64 of the anvil. This eliminates the need for drilling or for using a lathe to create the required inner and outer diameters. Thus, material is not lost to these processes. Additionally, time is not lost to these processes. The reduction of waste and the simplified method of creating the anvil 60 results in significant reduction in the cost of manufacturing the anvil. It is estimated that the cost of manufacturing the anvil is reduced by thirty to forty percent using the wrapping process instead of machining the anvil.

In addition to the cost benefits which are provided by the wrapped anvil 60, there are also structural benefits. The wire stock 80 used to make the anvil 60 is generally purchased in spools of hundreds or thousands of feet. Because the anvil 60 used in the blind fastening systems are generally very small, dozens of anvils 60 can be formed from a single foot of wire stock. Because the material properties of the wire stock are generally consistent throughout the continuous spool, the material properties of anvils made from that spool will also be consistent. The material consistency is important for consistent operation of the anvil within the blind fastening system.

While a preferred embodiment of the present invention is shown and described, it is envisioned that those skilled in the art may devise various modifications of the present invention without departing from the spirit and scope of the appended claims.

The invention claimed is:

1. An anvil for use with a fastening system, said anvil comprising:
a first portion having opposite first and second ends;
a second portion extending radially outwardly from said second end of said first portion; and
wherein said anvil is formed by a wrapping material around a mandrel.

2. An anvil as defined in claim 1, wherein said anvil further includes a slot.

3. An anvil as defined in claim 2, wherein said slot has an angle of sixty degrees or less.

4. An anvil as defined in claim 1, wherein said material is wire.

5. A method of wrapping an anvil for use in a fastening system comprising the steps of:
forming a piece of wire to create a first portion and a second portion, said second portion extending radially outwardly from said first portion;
cutting said wire to a predetermined length to form two free ends;
providing a mandrel; and
wrapping said wire around said mandrel.

6. A method as defined in claim 5, further comprising the step of:
placing said mandrel and said wire within a groove of a brace.

7. A method as defined in claim 5, further comprising the step of:
forcing said free ends against said mandrel such that said free ends are spaced apart from each other at a predetermined distance.
